(19) United States
(12) Patent Application Publication
(10) Pub. No.: US 2013/0071799 A1
(43) Pub. Date: Mar. 21, 2013

(54) ALL-VEGETABLE OIL CANDLES MANUFACTURED FROM HIGH PURITY STEARIN

(71) Applicant: Dow AgroSciences LLC, Indianapolis, IN (US)

(72) Inventors: Asim Syed, Carmel, IN (US); Carl Vincent DeAmicis, Indianapolis, IN (US); Gregory Todd Whiteker, Carmel, IN (US); Thomas G. Patterson, Westfield, IN (US); Josh Flook, Tipton, IN (US); James Todd Gerdes, Breckenridge, MN (US); Charles James Kahl, Westfield, IN (US); Angela Lee Erickson, Fergus Falls, MN (US); Robert Martin Benson, Ellsworth, WI (US)

(73) Assignee: DOW AGROSCIENCES LLC, Indianapolis, IN (US)

(21) Appl. No.: 13/668,101

(22) Filed: Nov. 2, 2012

Related U.S. Application Data
(63) Continuation-in-part of application No. 12/340,558, filed on Dec. 19, 2008.
Application No. 12/340,558 is a continuation-in-part of application No. 12/340,525, filed on Dec. 19, 2008.
(60) Provisional application No. 61/015,591, filed on Dec. 20, 2007.
(60) Provisional application No. 61/015,591, filed on Dec. 20, 2007.

(51) Int. Cl. C11C 5/00

(52) U.S. Cl. CPC C11C 5/002
USPC 431/291; 431/288; 427/398.1; 44/275; 83/13

(57) ABSTRACT

This disclosure concerns methods for manufacturing candles using a high-purity stearin that may be produced from certain hydrogenated sunflower oils without requiring the separation of stearin from other fatty acids in the hydrogenated oil. This disclosure also concerns candles made by the foregoing manufacturing process, which candles may be of higher quality and cheaper to manufacture than conventional candles.

### CROSS-REFERENCE TO RELATED APPLICATIONS

This application is a continuation-in-part of co-pending U.S. patent application Ser. No. 12/340,558, filed Dec. 19, 2008, and U.S. patent application Ser. No. 12/340,525, filed Dec. 19, 2008, the contents of the entirety of each of which is incorporated herein by this reference. U.S. patent application Ser. No. 12/340,558 and U.S. patent application Ser. No. 12/340,525 both claim priority under 35 U.S.C. §119(e) to U.S. Provisional Patent Application Ser. No. 61/015,591, filed Dec. 20, 2007.

### FIELD OF THE DISCLOSURE

The present disclosure relates to the manufacture of candles utilizing stearin produced by the hydrogenation of novel sunflower oils comprising high oleic acid and/or low palmitic acid/saturated fat. Some aspects of the disclosure relate to candles manufactured using stearin from particular sunflower germplasm that is characterized by stabilized oil traits.

### BACKGROUND

Oils and fats used for preparation of foods include vegetable oils that may be extracted from seeds of the cultivated sunflower (Helianthus annuus L.). Sunflower oil is generally considered a premium oil because of its light color, high level of unsaturated fatty acids, lack of linolenic acid, bland flavor, and high smoke point. Chemically, vegetable oils include glycerin triesters, and they typically contain fatty acids having 16 to 20 carbon atoms, monoglycerides, diglycerides, and triglycerides. While other “unusual” fatty acids exist in plants, most vegetable oils (e.g., sunflower oil) comprise predominantly palmitic (16:0), stearic (18:0), oleic (18:1), linoleic (18:2) and linolenic (18:3) acids in characteristic amounts. See, e.g., Harwood, J. L. (1980) “Plant acyl lipids: structure, distribution and analysis.” In The Biochemistry of Plants (P. K. Stumpf and E. E. Conn, eds.), Vol. 4, pp. 1-55. Academic Press, New York. The primary fatty acids in sunflower oil are the unsaturated fatty acids, oleic acid and linoleic acid.

Through highly labor intensive and uncertain research efforts, elite cultivars of many commercial oil plants have been produced (e.g., through selective breeding, and through recombinant genetic technology) that exhibit stable and characteristic oil traits. It is a difficult and uncertain challenge to incorporate and stabilize a trait of interest into high yielding cultivars of commercial crop plants (e.g., sunflower). The difficulty is increased by several orders of magnitude if a breeder attempts to combine multiple traits into one cultivar. For a plant breeder to find a cultivar with sufficient merit (e.g., high yielding) to be increased and commercially distributed, it is necessary to make many crosses and grow thousands of experimental genotypes. The evaluation of so many genotypes is a huge task, and consumes an enormous amount of the plant breeder's time and budget. If the plant breeder is fortunate, it can take a decade or more from the time the original cross is made to the time when a commercially viable genotype is identified. If the plant breeder is unfortunate, a certain trait or combination of traits may be impossible to incorporate into a particular germplasm, where the source of the failure most often is never known or able to be determined.

Acceptable lines for the introduction of a specific allele have background genotypes that compensate for or are mainly unaffected by the perturbations caused by the introduced allele. When lines with alleles contributing to multiple traits of interest (e.g., oil traits of interest) are combined by breeding, the background genotypes that have adjusted to the introduced alleles are combined, and new genotypes must be selected. The frequency of genotypes with suitable yield will be reduced accordingly. Notwithstanding the foregoing, once a particular combination of oil traits have been combined in a variety, then the traits can be transferred to other genetic backgrounds.

Saturated fatty acids generally have higher melting points than an unsaturated fatty acid of the same carbon number. Accordingly, an unsaturated vegetable oil may be partially or completely hydrogenated to increase the melting point of the vegetable oil. In the hydrogenation process (also sometimes referred to as “hardening”), a carbon-carbon double bond is reduced by molecular hydrogen (H₂), thereby forming an alkane from the alkene fatty acid substrate. If all of the carbon-carbon double bonds in the substrate molecule are reduced by this process, the process may be referred to as “complete hydrogenation.” As the hydrogenation of an unsaturated oil proceeds towards completion, the degree of the molecular substrate's saturation increases, while the viscosity and the melting point of the oil correspondingly increase.

The triglyceride of the saturated fatty acid, stearic acid, is commonly referred to as “stearin,” or “tristearin.” Stearin is often used in candle-making to raise the melting point of the wax mixture, making the resulting candle harder and more durable.

Commercially produced candles are typically manufactured from a stearin/paraffin or stearin/tallow mixture. Paraffin is a popular component of the wax mixture, because it costs less to produce and burns cleaner than tallow. Paraffin, which has a low melting point (i.e., between 45 and 60° C.), overcomes the hardening effect of stearin (which has a melting point of up to 71° C.) in the candle wax mixture. As the relative amount of stearin in the wax mixture rises, the resulting candle will drip less, sag less, and burn longer. 100% stearin can be used to produce a dripless, smokeless, and comparatively long-lived candle.

Although stearin is naturally available, fats with a solid structure and a major fatty acid chain ranging from C14 to C20 are typically obtained by hydrogenation of liquid vegetable oils comprising unsaturated fatty acids (e.g., soy, rapeseed, sunflower, and groundnut oil). However, most of the hydrogenation in such processes typically occurs on the end fatty acids of the triglycerides, because the center arm of the triglyceride is shielded by the end fatty acids to some extent. This phenomenon causes the resulting products to be more brittle (e.g., such that the wax tends to crack unattractively upon solidifying), and it is one reason why the use of vegetable wax for candle-making is generally undesirable.

### BRIEF SUMMARY OF THE DISCLOSURE

Described herein is a wax mixture that is suitable for candle making, and candles manufactured, at least in part, from such a wax mixture. In embodiments, the wax mixture may comprise a high purity stearin produced from a sunflower oil comprising an oil trait that is characteristic of the sunflower variety from which the sunflower oil was obtained. In some embodiments, a high purity stearin comprised within a wax mixture may be produced from a sunflower oil comprising: a low saturated fat content; a low palmitic acid content; a high oleic acid content; and/or a high content of C18 fatty acids that is characteristic of the sunflower variety from which the sunflower oil was obtained.

Also described herein are methods of making a candle having one or more advantageous characteristics, for example and without limitation, slower burning, more consistent burning, more structurally stable, less dripping, and less smoke-producing. In embodiments, such a candle may be manufactured from a high purity stearin produced from a sunflower oil comprising an oil trait (e.g., a low saturated fat content; a low palmitic acid content; a high oleic acid content; and/or a high content of C18 fatty acids) that is characteristic of the sunflower variety from which the sunflower oil was obtained.

Yet another embodiment includes a method of manufacturing a candle by providing the aforementioned compositions, heating the composition until it is in a molten state, cooling the molten composition into a solid form, and finishing the candle from the solid form.

The foregoing and other features will become more apparent from the following detailed description of several embodiments.

### DETAILED DESCRIPTION

### I. Overview of Several Embodiments

Due to its many desirable properties (e.g., high melting point), stearin is needed in candle-making to manufacture the highest quality candles. Most of the candles in the market today are manufactured with beeswax, lard stearin, or petroleum fractions. Beeswax is expensive, and unrefined lard candles are typically poor-quality and have an undesirable aroma. Candles manufactured from refined lard offer some improvement over those manufactured from unrefined lard, but refined lard is relatively expensive.

An alternate source of material for the manufacture of candles is hydrogenated vegetable oil. However, because vegetable oils comprise mixtures of different carbon-length fatty acids, hydrogenated vegetable oils contain a mixture of, inter alia, palmitic and stearic aids. It is stearic acid triglyceride this is particularly desirable for candle-making, due to its higher melting point.

Some embodiments of the invention utilize particular raw (i.e., unprocessed) sunflower oils, or mixtures of the same, that are hydrogenated to provide stearin for the manufacture of a candle. In some embodiments, one benefit of this raw material is its high oleic acid content that was previously unobtainable in a raw sunflower oil, which, when fully hydrogenated, produces high purity (e.g., at least about 96%) stearin. Such high purity stearin is, for all practical purposes, as potent as 100% stearin. Accordingly, particular embodiments utilize hydrogenated sunflower oils that have not been separated (e.g., through hydrolysis and/or molecular distillation), and which comprise high concentrations of stearic acid that are novel, and which are suitable to be used as a raw material to formulate a high-quality all vegetable oil-based candle.

Embodiments of the invention provide methods for the manufacture of a candle (and a candle manufactured thereby) utilizing stearin from particular novel sunflower oils (e.g., Reduced Saturate Sunflower (RSS) oils) that are produced by sunflower varieties comprising a characteristic fatty acid content. RSS oils typically comprise at least about 80% oleic acid, and when hydrogenated, provide a higher-purity stearin than is available from hydrogenation of conventional sunflower oils without further processing or purification. In particular examples, an RSS oil may comprise at least about 90% oleic acid (e.g., about 92% oleic acid), and when fully hydrogenated, may provide at least about 95% stearic acid (e.g., about 96% stearic acid). Candles that are provided in some embodiments comprise essentially a single hard-melting fatty acid (i.e., stearin) in their structural material that provides advantageous properties, for example and without limitation: relatively slow, consistent, and/or smokeless burning.

### II. Abbreviations

FAME fatty acid methyl ester

GC gas chromatography

IV iodine value

NIR near infrared spectroscopy

NMR nuclear magnetic resonance spectroscopy

RSS reduced saturate sunflower

TOTSAT total saturated fat content

### III. Terms

In the description and tables which follow, a number of terms are used. In order to provide a clear and consistent understanding of the specification and claims, including the scope to be given such terms, the following definitions are provided.

Characteristic: As used herein with regard to traits and phenotypes, the term “characteristic” denotes that a particular plant or cultivar may be identified by the existence of the trait/phenotype. For example, a “characteristic trait” in an elite sunflower cultivar may be an observable trait that distinguishes the elite sunflower cultivar from other cultivars. It is understood in the art that the extent to which a characteristic trait is observable in a plant may be influenced by other than genetic factors (e.g., it may be influenced in part by environmental factors). However, a characteristic trait is subject to a very significant level of genetic control, such that a cultivar comprising the characteristic trait may be used in practice to identify and distinguish the cultivar from other cultivars. In certain embodiments herein, characteristic traits of particular interest in sunflower are reduced levels of saturated fatty acids and high oleic acid content.

Elite: An “elite” sunflower cultivar is one which has been stabilized for certain commercially important agronomic traits comprising a stabilized yield of about 100% or greater relative to the yield of check varieties in the same growing location growing at the same time and under the same conditions. An “elite sunflower” in certain examples may refer to a sunflower cultivar stabilized for certain commercially important agronomic traits comprising a stabilized yield of 110% or greater (e.g., 115% or greater), relative to the yield of check varieties in the same growing location growing at the same time and under the same conditions.

Fatty acid: As used herein, the term “fatty acid” refers to a long chain (more than 8-10 carbon atoms) straight- or branched-saturated, monounsaturated, or polyunsaturated hydrocarbon chain bonded to a terminal carboxyl group. The term “fatty acid” also encompasses the fatty acid moieties of monoglycerides, diglycerides and triglycerides, which are the major constituents of sunflower oils.

Fatty acid content: As used herein, the term “fatty acid content” refers to the relative concentration of each fatty acid in an oil. Examples of particular fatty acids, the relative concentration of which may be determined in an oil (e.g., via FAME analysis), includes without limitation: oleic acid (18:1); linoleic acid (18:2); lauric acid (C12:0); myristic acid (C14:0); palmitic acid (C16:0); stearic acid (C18:0); arachidic acid (C20:0); behenic acid (C22:0); and lignoceric acid (C24:0).

The percentage of total fatty acids can be determined by extracting a sample of oil from seed, producing the methyl esters of fatty acids present in that oil sample, and utilizing GC to analyze the proportions of the various fatty acids in the sample. The fatty acid composition can also be a distinguishing characteristic of a variety.

Total saturated fat content (TOTSAT): As used herein, “TOTSAT” refers to the total percent oil of the seed of the saturated fats in the oil. Saturated fats that may be found in an oil include, for example: C12:0; C14:0; C16:0; C18:0; C20:0; C22:0; and C24:0.

Fatty acid methyl ester (FAME) analysis: FAME analysis is a method that allows for accurate quantification of the fatty acids that make up complex lipid classes. In a typical FAME analysis, fatty acid methyl esters are created through an alkali-catalyzed reaction between fats or fatty acids in a sample and methanol. The fatty acid methyl esters can then be analyzed utilizing gas chromatography (GC).

High purity stearin: As used herein, the term “high purity stearin” may refer to a hydrogenated sunflower oil comprising a combined stearic acid and palmitic acid content of at least about 97% of the total fatty acids in the oil, and a stearic acid content of at least about 90% of the total fatty acids in the oil. Thus, in certain examples, a “high purity stearin” is a hydrogenated sunflower oil comprising a combined stearic acid and palmitic acid content of, for example, at least 96.5%; at least 97.0%; at least 97.5%; at least about 98.0%; at least about 98.5%; at least about 99.0%; and at least about 99.5% of the total fatty acids in the oil, and a stearic acid content of, for example, at least 89%; at least 90%; at least 91%; at least about 92%; at least about 93%; at least about 94%; at least about 95%; at least about 96%; and at least about 97% of the total fatty acids in the oil. A “high purity stearin” may also be fully saturated or essentially fully saturated (i.e., at least about 97%, at least about 97.5%, at least about 98.0%; at least about 98.5%; at least about 99.0%; and/or at least about 99.5% of the total fatty acids in the oil are saturated fatty acids).

Oil content: The “oil content” of a seed or plant cultivar is typically expressed as a mass percentage of the whole dried seed of the cultivar. Oil content is a characteristic trait of different elite sunflower cultivars. Oil content may be determined using any of various analytical techniques including, for example and without limitation: NMR; NIR; and Soxhlet extraction.

Stabilized: As used herein in regard to traits/phenotypes, the term “stabilized” refers to traits/phenotypes that are reproducibly passed from one generation to the next generation of inbred plants of the same variety.

Wax: As used herein, the term “wax” refers to a material that is a solid at room temperature, a liquid at higher temperatures, primarily hydrocarbon in structure, hydrophobic, insoluble in water, smoothly textured, and capable of being buffed under slight mechanical pressure. Waxes are typically primarily hydrocarbons, and a wax may be of animal, vegetable, or petroleum origin.

### IV. High Purity Stearin

A method for manufacturing a candle may in embodiments comprise utilizing a high purity stearin produced, for example, by hydrogenating a sunflower oil to produce stearin. In particular examples, a high purity stearin is a hydrogenated sunflower oil from one or more specific sunflower varieties that are characterized, at least in part, by producing an oilseed that comprises a low saturated fat content and/or a high oleic acid content. Thus, particular examples include methods for manufacturing a candle utilizing a high purity stearin produced by hydrogenating a raw (i.e., unprocessed) sunflower oil comprising a characteristic low saturated fat content and/or a characteristic high oleic acid content. Examples of specific sunflower varieties capable of producing such a characteristic raw sunflower oil include, for example and without limitation, a sunflower variety set forth in Table 2 or Table 3.

In some embodiments, a method for manufacturing a candle may comprise utilizing a high purity stearin produced (e.g., by hydrogenation) from a sunflower oil comprising about 4% or less total saturated fatty acids. In particular embodiments, the sunflower oil may comprise, for example and without limitation, 4.2% or less; 4.1% or less; 4.0% or less; about 3.9% or less; about 3.8% or less; about 3.6% or less; about 3.4% or less; about 3.3% or less; about 3.2% or less; about 3.1% or less; about 3.0% or less; about 2.9% or less; about 2.8% or less; about 2.6% or less; about 2.4% or less; about 2.2% or less; and between about 4% and about 2% saturated fatty acids. Particular examples include methods for manufacturing a candle utilizing a high purity stearin from the hydrogenated sunflower oil of one or more specific sunflower varieties that are characterized, at least in part, by producing an oilseed that comprises an oil having about 4% or less total saturated fatty acids. Examples of such specific sunflower varieties include, for example and without limitation, a sunflower variety set forth in Table 2.

In some embodiments, a method for manufacturing a candle is provided, wherein the method comprises providing a high purity stearin produced from a sunflower oil comprising at least about 80% oleic acid. In particular embodiments, the method may comprise utilizing a high purity stearin produced from a sunflower oil comprising, for example and without limitation, at least about 80% (e.g., at least 79%, at least 79.5%, at least 80%, at least 80.5%, and at least 81%); at least about 81%; at least about 82%; at least about 83%; at least about 84%; at least about 85%; at least about 86%; at least about 87%; at least about 88%; at least about 89%; at least about 90%; at least about 91%; at least about 92%; at least about 93%; at least about 94%; at least about 95% oleic acid; and between about 80% and about 96% oleic acid. Particular examples include methods for manufacturing a candle is provided, wherein the method comprises providing a high purity stearin from the sunflower oil of one or more specific sunflower varieties that are characterized, at least in part, by producing an oilseed that comprises an oil having at least about 88% oleic acid. Examples of such specific sunflower varieties include, for example and without limitation, a sunflower variety set forth in Table 4.

In some embodiments, a method for manufacturing a candle may comprise utilizing a high purity stearin produced from a sunflower oil comprising at least about 93% combined C18 fatty acids; and hydrogenating the sunflower oil. In particular embodiments, the sunflower oil may comprise, for example and without limitation, at least about 93% (e.g., at least 92%, at least 92.5%, at least 93%, at least 93.5%, and at least 94%); at least about 93.5%; at least about 94%; at least about 94.5%; at least about 95%; at least about 95.5%; at least about 96%; at least about 96.5%; and at least about 97% combined C18 fatty acids. Particular examples include methods for manufacturing a candle utilizing a high purity stearin from the hydrogenated sunflower oil of one or more specific sunflower varieties that are characterized, at least in part, by producing an oilseed that comprises an oil having at least about 93% combined C18 fatty acids. Examples of such specific sunflower varieties include, for example and without limitation, a sunflower variety set forth in Table 2 and Table 3.

In some embodiments, a method for manufacturing a candle may comprise utilizing a high purity stearin produced from a sunflower oil comprising about 3% or less palmitic acid. Examples of such specific sunflower varieties include, for example and without limitation, a sunflower variety set forth in Table 5. In some embodiments, a method for manufacturing a candle is provided, wherein the method comprises providing a high purity stearin produced from a sunflower oil comprising about 3.5% or less total combined palmitic acid and stearic acid. In some embodiments, a method for manufacturing a candle is provided, wherein the method comprises providing a high purity stearin produced from a sunflower oil comprising at least about 88% oleic acid and about 3% or less palmitic acid. Examples of such specific sunflower varieties include, for example and without limitation, a sunflower variety set forth in Table 6.

In particular embodiments, a high purity stearin may be produced by a method comprising hydrogenation of a particular sunflower oil (e.g., as set forth, supra). Hydrogenation in such a method may comprise, for example and without limitation, dissolving the particular sunflower oil in a solvent; hydrogenation utilizing a metal catalyst (e.g., Ni, Pd, Pt, Rh, and Ru); hydrogenation at ambient temperature; hydrogenation at an elevated (i.e., higher than ambient) temperature; hydrogenation at an ambient pressure; and hydrogenation at an elevated (i.e., higher than ambient) pressure, so as to produce the high purity tristearin.

Some embodiments include a method for manufacturing a candle may comprise utilizing a high purity stearin produced by hydrogenating a sunflower oil having a low saturated fat content. A sunflower oil having a low saturated fat content may include, for example and without limitation: about 4% or less (e.g., 4.2% or less, 4.1% or less, 4.0% or less, about 3.9% or less, and about 3.8% or less); about 3.6% or less; about 3.4% or less; about 3.3% or less; about 3.2% or less; about 3.1% or less; about 3.0% or less; about 2.9% or less; about 2.8% or less; about 2.6% or less; about 2.4% or less; about 2.2% or less; and between about 4% and about 2% total combined palmitic acid (16:0) and stearic acid (18:0) content. For example, the sunflower oil may be derived from at least one sunflower plant that is stabilized for the characteristic production of seeds comprising a decreased saturated fat content.

Sunflower plants that are stabilized for the characteristic production of seeds comprising a decreased saturated fat content include, for example, the sunflower varieties set forth in Table 2 and Table 3 of the Examples. Seed from plants of any of these sunflower cultivars may be utilized in some embodiments to provide a sunflower oil having a low saturated fat content, from which a high purity stearin is produced for candle-making.

A sunflower oil having a low saturated fat content may specifically comprise a low palmitic acid content, for example and without limitation: about 3% or less (e.g., 3.2% or less, 3.1% or less, 3.0% or less, about 2.9% or less, and about 2.8% or less); about 2.8% or less; 2.6% or less; about 2.4% or less; about 2.3% or less; about 2.2% or less; about 2.1% or less; about 2.0% or less; about 1.9% or less; about 1.8% or less; about 1.7% or less; about 1.6% or less; about 1.5% or less; about 1.4% or less; and between about 3% and about 1.3% palmitic acid. For example, the sunflower oil may be derived from at least one sunflower plant that is stabilized for the characteristic production of seeds comprising a decreased saturated fat content.

Sunflower plants that are stabilized for the characteristic production of seeds comprising a decreased saturated fat content and, specifically, a low palmitic acid content include, for example, the sunflower varieties set forth in Table 5 of the Examples. Seed from plants of any of the foregoing sunflower cultivars may be utilized in some embodiments to provide a sunflower oil having a low palmitic acid content, from which a high purity stearin is produced for candle-making.

In some embodiments, a candle may be manufactured from a high purity stearin produced by a method comprising the hydrogenation of a sunflower oil comprising a high (e.g., at least about 80%, at least 88.66%, and at least about 90%) oleic acid content. A high oleic acid sunflower oil may be derived from sunflower seeds produced by a plant that has been genetically modified to yield a characteristic high oleic content, for example, an Omega-9® (Dow AgroSciences LLC, Indianapolis, Ind.) sunflower oil. Omega-9® sunflower oil is a sunflower oil having an oleic acid (18:1) content of at least about 80% (e.g., at least 79%, at least 79.5%, at least 80%, at least 80.5%, and at least 81%), and an α-linolenic acid (18:3) content of less than about 1%. For example and without limitation, an Omega-9® sunflower oil may comprise at least about 81%; at least about 82%; at least about 83%; at least about 84%; at least about 85%; at least about 86%; at least about 87%; at least about 88%; at least about 89%; at least about 90%; at least about 91%; at least about 92%; at least about 93%; at least about 94%; at least about 95% oleic acid; and between about 80% and about 96% oleic acid.

Sunflower plants that are stabilized for the characteristic production of seeds comprising a high oleic acid content include, for example, the sunflower varieties set forth in Table 4 of the Examples. Seed from plants of any of the foregoing sunflower cultivars may be utilized in some embodiments to provide a sunflower oil having a high oleic acid content, from which is produced a high purity stearin for candle-making.

In some embodiments, a candle may be manufactured from a high purity stearin produced by a method comprising the comprising the hydrogenation of a sunflower oil comprising a low saturated fat (e.g., palmitic acid (16:0)) content and a high oleic acid content. The combination of high oleic acid content with low palmitic acid content allows for hydrogenation of the oil to produce a high purity stearin hard fat through use of a simple manufacturing process comprising full hydrogenation of the oil. Sunflower plants that are stabilized for the characteristic production of seeds comprising a high oleic acid content and a low palmitic acid content include, for example, the sunflower varieties set forth in Table 6 of the Examples. Seed from plants of any of the foregoing sunflower cultivars may be utilized in some embodiments to provide a sunflower oil having a low saturated fat content and high oleic acid content, from which is produced a high purity stearin for candle-making.

In particular examples of sunflower plants that provide a raw sunflower oil for the production of a high purity stearin for candle-making, the combination of a low palmitic acid trait with a high oleic acid trait results in oilseed with oil profiles containing up to about 94% oleic acid and less than 2.1% palmitic acid. The combination of high C18 fatty acid content with low C16 fatty acids (which was previously unobtainable in a raw sunflower oil) may be exploited to produce what is essentially reagent grade high purity stearin using a very simple manufacturing process without certain purification steps. Full hydrogenation of this sunflower oil (i.e., converting essentially all of the unsaturated C18 fatty acids to stearic acid) may yield a hard fat comprising a total stearic acid content of at least 96%. In such a hard fat, the contents of stearic and palmitic acids together may account for over 98% of the total fatty acids in the fat. These hard fats may be used as a material for the manufacture of a candle in particular embodiments.

As previously indicated, particular embodiments of the invention utilize a high purity stearin produced by hydrogenation of a raw sunflower oil produced by one or more elite sunflower cultivars with the stabilized oil trait(s) of low saturated fat content; low palmitic acid content; and/or high oleic acid content. Quantities of stearin produced by hydrogenating oils produced by several such cultivars may be combined in some examples. In others, the stearin is from an oil produced by a single such cultivar. In addition to the representative suitable sunflower cultivars described in Table 2, Table 3, Table 4, Table 5, and Table 6, it will be understood that other suitable sunflower cultivars may be produced by crossing these representative cultivars, where the oil trait(s) have been successfully and stably combined, with another sunflower cultivar. Further, other suitable sunflower cultivars may be produced by mutagenesis or transformation of the representative cultivars. Some embodiments utilize a stearin from a sunflower oil produced by one or more such other suitable sunflower cultivar(s).

Hydrogenation of a high oleic acid and/or low saturated fat (e.g., low palmitic acid) sunflower oil during the production of a high purity stearin for use in particular embodiments may be performed according to any of many specific protocols known in the art, such as, for example and without limitation, by heating the oil with metal catalysts in the presence of pressurized hydrogen gas. For example, the hydrogenation may be conducted in a solvent (e.g., toluene, chloroform) or “neat,” and it can be conducted at ambient or elevated (e.g., 80-200° C.) temperatures and ambient or elevated pressures (e.g., 1-5 atms). A variety of metal catalysts may be used in the hydrogenation, including for example and without limitation: nickel (Pricat9910, Raney, etc.); palladium; platinum; rhodium; and ruthenium.

During hydrogenation, hydrogen atoms are incorporated into the fatty acid molecules, such that they become saturated. For example, oleic acid (C18:1) and linoleic acid (C18:2) are both converted to stearic acid (C18:0) when fully saturated. The degree of hydrogenation of the liquid oil can be controlled by known practice, resulting in a range of saturation from partially hydrogenated to fully hydrogenated fats. Through such known techniques, the liquid vegetable oil can become a solid, fully saturated fat.

In some examples, a stearin utilized in candle-making may be produced via the hydrogenation of a high oleic acid and/or low saturated fat (e.g., low palmitic acid) sunflower oil in the presence of a palladium on activated carbon catalyst. The use of a palladium (or platinum) catalyst reduces the formation of partially saturated trans-isomers during the hydrogenation. Because the heavy metal catalyst is highly toxic, the removal of the catalyst from the product must be almost complete. Thus, a high purity stearin utilized in some embodiments may be subjected to a purification step whereby a catalyst is removed from the stearin. This purification is a separate and distinct process from the separation of stearin from other fatty acids in the product, the elimination of which process is a particular benefit of some embodiments.

According to the foregoing, some embodiments of the invention utilize an oil product produced by the full or partial hydrogenation of a sunflower oil comprising a low saturated fat content (e.g., a low palmitic acid content) and/or a high oleic acid content. Particular embodiments utilize a high purity stearin produced by the full hydrogenation of such a sunflower oil. A high purity stearin that is provided in some embodiments is suitable for use, without certain costly processing steps, as a reagent grade stearin in candle-making. In specific applications, a high purity stearin may be combined with one or more other saturated, partially-saturated, or unsaturated oil(s) to produce a blended oil product that may be used to produce a candle with particular desirable properties.

The degree of saturation (and hydrogenation) in an oil may be measured by determining the “iodine value” of the oil. The iodine value is the mass of iodine that is consumed by 100 grams of the oil. As discussed above, fatty acid unsaturation is in the form of double bonds, which bonds may react with iodine compounds, as well as with molecule hydrogen. The higher the iodine value of an oil, the more carbon-carbon double bonds are present in the oil. The lower the iodine value of an oil, the higher the degree of saturation/hydrogenation, and the higher the melting point, of the oil.

### IV. Manufacture of all-Vegetable Oil Candles from High Purity Stearin

In embodiments, a high purity stearin may be utilized to manufacture a candle, for example, a candle that has one or more desirable characteristics attributable to the presence of stearin in the candle body. In some embodiments, the candle may be an all-vegetable oil candle. A high purity stearin may be provided for use in a method for manufacturing a candle in powder, liquid, or granulated form. A high purity stearin generally may have a white color and a greasy or oil feel. The melting point of a high purity stearin approaches 158° F. (70° C.). In some embodiments, a high purity stearin is mixed with a wax (e.g., paraffin and tallow) and/or oil (e.g., a vegetable oil) to produce a wax mixture, an oil mixture, or a wax/oil mixture. Typically, a mixture comprising a high purity stearin will be fitted with a wick (e.g., zinc core wick, paper core wick, and cotton wick), and allowed to harden. The hardened mixture may constitute the candle, per se, or it may be further sculpted, fashioned, or decorated according to any technique known in the art. The melting point of a bar candle is typically about 130-140° F., and the melting point of a jar candle is typically about 110-120° F.

As is known in the art, stearin may be utilized in different amounts in a wax mixture for candle-making to impart a variety of different characteristics to a candle manufactured therefrom. For example, a lower ratio of stearin to wax can be provided to yield a “snowflake” effect. In higher proportions, stearin renders the wax more opaque, and the colors brighter. The crystalline structure of stearin can also be used to confer a lacquered appearance to the finished candle. The choice of how much stearin to include in a wax mixture in individual examples is made according to the discretion of the skilled practitioner. In particular embodiments, a wax mixture that is formed into a candle may comprise, for example and without limitation, at least about 10% stearin; at least about 20% stearin; at least about 30% stearin; and at least about 40% stearin. As the amount of stearin in the wax mixture is increased, the resulting candle will become more opaque (or pastel if the candle is colored).

In some embodiments, a high purity stearin is utilized in an oil mixture to produce an all-vegetable oil candle. In examples, an oil mixture that is formed into an all-vegetable oil candle may comprise, for example and without limitation: 100% high purity stearin; about 90% high purity stearin+about 10% liquid oil; about 80% high purity stearin+about 20% liquid oil; about 75% high purity stearin+about 25% liquid oil; and about 70% high purity stearin+about 30% liquid oil. A liquid oil used in combination with a high purity stearin to provide an oil mixture may be, for example, an RSS oil.

In embodiments, a candle may be manufactured utilizing a high purity stearin according to any method known in the art. For example and without limitation, a candle manufactured utilizing a high purity stearin may be manufactured using a mold, a spray process, a spray/pressing process, a cut & carve process, and a dipping process. When utilized in the production of molded candles, stearin may be mixed with paraffin and/or tallow, such that the mixture shrinks as it cools. Such shrinkage simplifies the removal of the candle from the mold. It may be desirable to avoid the use of rubber and/or latex molds, however, as stearin (an acid) can degrade rubber and latex. The choice of which manufacturing process(es) to employ in individual examples is within the discretion of the skilled practitioner.

In particular embodiments, a candle may be manufactured from more than one wax mixture and/or oil mixture. For example and without limitation, in the process of “overdipping,” a candle may be manufactured by dipping one hardened wax or oil mixture in a separate mixture with a higher melting point (e.g., a mixture with a higher amount of stearin). This process may be employed to manufacture a candle comprising a harder outer surface that is more resistant to melting than the interior of the candle body. As such a candle burns down, the outer surface remains longer than the interior body that is more easily converted to a molten state. Accordingly, less of the candle body drips away from the burning candle, thereby reducing mess and extending the useful life of the candle.

In addition to a high purity stearin and a wax and/or oil, a mixture that may be hardened in some embodiments as part of a process for manufacturing a candle may contain one or more additives, including for example and without limitation: a coloring agent (e.g., a dye); a botanical; an aromatic compound; titanium dioxide; a candle glaze; vybar; and a UV stabilizer.

The following examples are provided to illustrate certain particular features and/or embodiments. The examples should not be construed to limit the disclosure to the particular features or embodiments exemplified.

### EXAMPLES

### Example 1

### FAME Protocol Using Saponification and BF₃ Methylation

A Fatty Acid Methyl Ester (FAME) protocol that utilized the saponification and methylation of fatty acids in oil for FAME analysis by GC-FID via boron triflouride (BF₃) was used for the FAME analysis of samples containing high levels of free fatty acids. Samples that contain significant levels of free fatty acids are not converted to methyl esters using traditional methoxide-catalyzed transesterification protocols.

First, about 10 mg (+/−2 mg) of an oil sample was portioned into a labeled 13×100 screw cap tube. Next, 300 μL 0.5N NaOH in methanol was added to each tube. The tubes were placed in a heating block set to 100° C. for 5.0 minutes. Then, the tubes were removed from the heating block and allowed to cool at room temperature for at least 1.0 minute. If the methanol had evaporated, the sample was reconstituted with 300 μL methanol before proceeding.

Next, 350 μL 14% BF₃ in methanol was added to each tube. The tubes were placed in a heating block set to 100° C. for 5.0 minutes, removed from the heat, and allowed to cool at room temperature for at least 1.0 minute.

Next, 2.000 mL heptane was added to each tube. The tubes were placed in a heating block set at 100° C. for 5.0 minutes, removed from the heating block, and allowed to cool at room temperature for at least 1.0 minute.

1.000 mL NaCl saturated Milli-Q™ water was then added to each tube, and the tubes were placed on a rocker for 5.0 minutes at room temperature. The tube was then centrifuged at 2,000 rpm for 10.0 minutes. Finally, 400 μL of supernatant was transferred to a labeled gas chromatography (GC) vial that contained 400 μL of glass insert. The GC vial was capped, and a 1.0-2.0 μL sample was injected into a 6890 Hewlett Packard GC-FID™ with a 7683 AutoSampler™ (Hewlett-Packard, Palo Alto, Calif.), and analyzed according to the instrument parameters provided in Table 1.

TABLE 1
The conditions for sample analysis run in a 6890 Hewlett
Packard GC-FID ™ with a 7683 AutoSampler ™.
Instrument Conditions
General:

| | |
|---|---|
| Front Inlet Type | S/SL EPC |
| Front Injector | — |
| Front Inlet | Yes |
| Column 1 | Yes |
| Front Detector | Yes |
| Channel 1 | Yes |

Column Conditions:

| | |
|---|---|
| Description | DB-23 |
| Length (m) | 60.00 |
| Diameter (μ) | 250 |
| Film Thickness (μ) | 0.25 |
| Gas Type | Helium |
| Mode | Constant Flow |
| Initial Pressure/Flow | 3.0 mL/min |

Oven Conditions:

| | |
|---|---|
| Isocratic Oven | Enable |
| Temperature Ramp | Constant |
| Maximum Temperature | 260° C. |
| Initial Temperature | 210° C. |
| Equilibrium Time | 0.50 minutes |

Injector Conditions - ctcPAL:

| | |
|---|---|
| Available Cycles | Dual GC-Inj3 |
| Syringe Vol | 10 μL |
| Air Volume (μL) | 0 |
| Pre Clean with Solvent 1 | 0 |
| Pre Clean with Solvent 2 | 0 |
| Pre Clean with Sample | 0 |
| Filling Speed (μL/s) | 8 |
| Filling Strokes | 3 |
| Inject to | GC Inj1 |
| Injection Speed (μL/s) | 100 |
| Pre Inject Delay (ms) | 0 |
| Post Inject Delay (ms) | 0 |
| Post Clean with Solvent 1 | 3 |
| Post Clean with Solvent 2 | 3 |

Inlet Conditions:

| | |
|---|---|
| Inlet Type | S/SL EPC |
| Mode | Split |
| Temp Enable | Yes |
| Initial Temp | 280° C. |
| Gas Saver | Yes |
| On Time | 5.00 |
| Flow | 15.0 |
| Split Ratio | 25.0 |
| Split Flow | 75.0 |

Detector Conditions - FID:

| | |
|---|---|
| Flame Enable | Yes |
| Setpoint | 300 |
| Oxidizer Flow | 400 |
| Fuel Flow | 30.0 |
| Flow Mode | Constant Makeup |
| Makeup/Combo Flow | 30.0 |

Channel Conditions:

| | |
|---|---|
| Select Source | Front Detector - Channel 1 |
| Sensitivity | HIGH |
| Sampling Rate | 10 |

Injection Volume: 2.0 μL
Run time: 16 minutes

### Example 2

### Materials and Methods

Elite Sunflower Cultivars Comprising Stabilized Characteristic Oil Traits

Reduced Saturate Sunflower (RSS) germplasm containing low saturate oil levels was developed. See U.S Patent Publication No. 2009/0169706 A1. RSS sunflower oils comprise about 4% or less total saturated fatty acids (e.g., about 3.5% or less total combined palmitic and stearic acid). In contrast, conventional sunflower lines possess seed oil content with about 13% total combined saturated fatty acids. This is a significant difference that may be used to identify and distinguish raw sunflower oil obtained from RSS germplasm from sunflower oil obtained from a conventional sunflower line. Oils produced by plants comprising a RSS germplasm also generally contain high levels of unsaturated fatty acids (e.g., oleic acid).

A large number of sunflower plants comprising a low saturated fat oil trait (e.g., RSS sunflower) were developed through plant breeding techniques, and their characteristic seed oil profiles are provided in Table 2 and Tables 3-6. Fatty acid composition analysis of the total seed oil content for each line was completed via FAME analysis. The results of the RSS oil samples were quantified and the FAME amounts were determined.

As expected, the oils of these lines contained significantly reduced saturated oil levels as compared to the saturate oil levels of conventional sunflower oil which have been previously reported in the literature. The total combined palmitic and stearic acid content of these particular cultivars is about 4% or less (e.g., about 3.5% or less, and from about 2.7% to about 3.5%). Most of these cultivars also have a characteristic high oleic acid content. For example, particular cultivars have an oleic acid content that is at least about 88% (e.g., from about 88% to about 95%).

TABLE 2
Seed oil content of certain sunflower cultivars having a total saturated fat
content less than about 4%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| he08ee017480.001.06 | 1.87 | 0.03 | 0.57 | 93.52 | 2.55 | 3.05 | 2.44 | 96.64 |
| NS1982.8 | 2.09 | 0.08 | 0.55 | 79.40 | 15.99 | 3.10 | 2.64 | 95.94 |
| (HX07ME095915.001) | | | | | | | | |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.16 | 1.52 | 0.06 | 1.05 | 94.37 | 0.85 | 3.39 | 2.57 | 96.27 |
| NS1982.16/ | 2.29 | 0.05 | 0.65 | 67.37 | 28.19 | 3.48 | 2.94 | 96.21 |
| OND163R-1-05 | | | | | | | | |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

TABLE 3
Seed oil content of certain low saturated fat sunflower cultivars having a
total saturated fat content higher than about 4%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| NS1982.14-08 | 1.51 | 0.02 | 2.24 | 92.84 | 1.35 | 4.90 | 3.75 | 96.43 |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| NS1982.8/ | 1.37 | 0.01 | 1.70 | 91.93 | 2.83 | 4.32 | 3.07 | 96.46 |
| OND163R-12-90 | | | | | | | | |
| H757B/ | 4.25 | 0.09 | 1.13 | 37.87 | 55.45 | 5.90 | 5.38 | 94.45 |
| LS10670B-B-17-3-14.01 | | | | | | | | |
| H757B/ | 4.80 | 0.11 | 0.68 | 39.63 | 53.55 | 6.05 | 5.48 | 93.86 |
| LS10670B-B-17-3-02.18 | | | | | | | | |
| H757B/ | 4.01 | 0.08 | 1.37 | 38.48 | 54.68 | 6.07 | 5.38 | 94.53 |
| LS10670B-B-17-3-27.12 | | | | | | | | |
| H757B/ | 5.19 | 0.14 | 0.73 | 35.14 | 57.79 | 6.22 | 5.92 | 93.66 |
| LS10670B-B-17-3-16.02 | | | | | | | | |
| H757B/ | 4.99 | 0.09 | 1.25 | 17.97 | 74.37 | 6.81 | 6.24 | 93.59 |
| LS10670B-B-17-3-36.22 | | | | | | | | |

TABLE 4
Seed oil content of certain low saturated fat sunflower cultivars having
an oleic acid content of at least about 88%.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| he08ee017480.001.06 | 1.87 | 0.03 | 0.57 | 93.52 | 2.55 | 3.05 | 2.44 | 96.64 |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |
| H757B/ | 4.25 | 0.09 | 1.13 | 37.87 | 55.45 | 5.90 | 5.38 | 94.45 |
| LS10670B-B-17-3-14.01 | | | | | | | | |

TABLE 5
Seed oil content of certain low saturated fat sunflower cultivars having a
palmitic acid content of about 3% or less.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| he08ee017480.001.06 | 1.87 | 0.03 | 0.57 | 93.52 | 2.55 | 3.05 | 2.44 | 96.64 |
| NS1982.8 | 2.09 | 0.08 | 0.55 | 79.40 | 15.99 | 3.10 | 2.64 | 95.94 |
| (HX07ME095915.001) | | | | | | | | |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| NS1982.16/ | 2.29 | 0.05 | 0.65 | 67.37 | 28.19 | 3.48 | 2.94 | 96.21 |
| OND163R-1-05 | | | | | | | | |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

TABLE 6
Seed oil content of certain low saturated fat sunflower cultivars having an oil content
comprising at least about 88% oleic acid and about 3% or less palmitic acid.

| | | | | | | TOTAL | C16:0 + | TOTAL |
|---|---|---|---|---|---|---|---|---|
| Sample | C16:0 | C16:1 | C18:0 | C18:1 | C18:2 | SATS | C18:0 | C18 |
| H757B/ | 2.34 | 0.09 | 0.48 | 94.18 | 1.51 | 3.39 | 2.82 | 96.17 |
| LS10670B-B-17-3-23.06 | | | | | | | | |
| H757B/ | 2.47 | 0.11 | 0.51 | 93.62 | 2.11 | 3.42 | 2.98 | 96.24 |
| LS10670B-B-17-3-33.11 | | | | | | | | |
| H757B/ | 2.24 | 0.09 | 0.53 | 94.25 | 1.49 | 3.45 | 2.77 | 96.27 |
| LS10670B-B-17-3-23.04 | | | | | | | | |
| H757B/ | 2.70 | 0.13 | 0.50 | 93.26 | 2.24 | 3.67 | 3.20 | 96.00 |
| LS10670B-B-17-3-02.08 | | | | | | | | |
| H757B/ | 2.45 | 0.11 | 0.54 | 93.62 | 1.73 | 3.68 | 2.99 | 95.89 |
| LS10670B-B-17-3-18.21 | | | | | | | | |
| HE06EE010716.001 | 2.17 | 0.11 | 0.82 | 94.29 | 1.41 | 3.63 | 2.99 | 96.52 |
| HE06EE010834.002 | 2.31 | 0.11 | 0.65 | 94.74 | 0.82 | 3.68 | 2.95 | 96.21 |
| HE06EE010746.002 | 2.40 | 0.11 | 0.72 | 93.87 | 1.03 | 3.68 | 3.12 | 95.62 |
| HE06EE010700.003 | 2.48 | 0.13 | 0.57 | 93.46 | 1.78 | 3.78 | 3.05 | 95.81 |
| HE06EE016032.005 | 2.42 | 0.10 | 0.64 | 92.86 | 1.82 | 3.82 | 3.06 | 95.32 |
| HE06EE016037.005 | 2.25 | 0.08 | 0.75 | 93.06 | 1.71 | 3.86 | 3.00 | 95.92 |
| HE06EE016032.002 | 2.40 | 0.10 | 0.70 | 93.00 | 1.72 | 3.87 | 3.09 | 95.42 |
| HE06EE010717.002 | 2.44 | 0.10 | 0.82 | 89.76 | 5.51 | 3.88 | 3.26 | 96.09 |
| HE06EE010695.001 | 2.48 | 0.12 | 0.66 | 91.93 | 3.20 | 3.88 | 3.14 | 95.79 |
| HE06EE010816.002 | 2.34 | 0.12 | 0.88 | 94.10 | 1.24 | 3.88 | 3.22 | 96.22 |
| HE06EE010700.001 | 2.48 | 0.14 | 0.65 | 94.31 | 0.89 | 3.90 | 3.13 | 95.85 |
| HE06EE010814.002 | 2.46 | 0.10 | 0.79 | 94.11 | 1.19 | 3.91 | 3.24 | 96.09 |
| HE06EE010760.004 | 2.54 | 0.11 | 0.63 | 94.07 | 1.16 | 3.92 | 3.16 | 95.86 |
| HE06EE010741.003 | 2.34 | 0.11 | 0.93 | 94.51 | 0.73 | 3.93 | 3.26 | 96.17 |
| HE06EE010737.003 | 2.33 | 0.13 | 0.96 | 93.53 | 1.12 | 3.93 | 3.29 | 95.61 |
| HE06EE016050.005 | 2.41 | 0.08 | 0.73 | 92.57 | 2.67 | 3.94 | 3.13 | 95.97 |
| HE06EE016032.004 | 2.44 | 0.11 | 0.63 | 92.49 | 1.80 | 3.94 | 3.07 | 94.92 |
| HE06EE010763.002 | 2.43 | 0.11 | 0.78 | 94.28 | 0.98 | 3.94 | 3.21 | 96.04 |
| HE06EE010829.002 | 2.53 | 0.13 | 0.70 | 93.26 | 1.84 | 3.95 | 3.23 | 95.80 |
| HE06EE010738.002 | 2.78 | 0.15 | 0.62 | 89.75 | 5.22 | 3.96 | 3.40 | 95.59 |
| HE06EE010741.004 | 2.42 | 0.11 | 0.88 | 94.10 | 0.61 | 3.96 | 3.30 | 95.59 |
| HE06EE010824.004 | 2.35 | 0.10 | 0.80 | 94.14 | 1.15 | 3.97 | 3.15 | 96.09 |
| HE06EE010745.003 | 2.81 | 0.11 | 0.68 | 88.66 | 6.32 | 3.98 | 3.48 | 95.66 |
| HE06EE010816.001 | 2.52 | 0.11 | 0.80 | 91.45 | 3.77 | 3.98 | 3.32 | 96.02 |
| HE08EE017394.001.04 | 1.49 | 0.02 | 0.66 | 93.70 | 2.46 | 2.86 | 2.15 | 96.82 |
| HE08EE017393.001.05 | 1.84 | 0.04 | 0.32 | 94.34 | 2.09 | 2.63 | 2.16 | 96.75 |
| HE08EE017352.001.03 | 1.63 | 0.06 | 0.91 | 92.62 | 3.18 | 3.27 | 2.54 | 96.71 |
| HE08EE017101.004.05 | 1.79 | 0.07 | 0.42 | 94.42 | 1.81 | 2.66 | 2.21 | 96.65 |
| he08ee017480.001.06 | 1.87 | 0.03 | 0.57 | 93.52 | 2.55 | 3.05 | 2.44 | 96.64 |
| NS1982.8 | 1.63 | 0.07 | 0.41 | 94.81 | 1.26 | 2.48 | 2.04 | 96.48 |
| (HX07ME095913.003) | | | | | | | | |
| NS1982.8 | 1.30 | | 2.00 | ~92 | 4.0 | | 3.30 | ~96 |
| NS1982.8/ | 2.75 | 0.66 | 0.25 | 92.95 | 1.99 | 3.43 | 3.00 | 95.19 |
| OND163R-2-12-009 | | | | | | | | |
| NS1982.8/ | 1.87 | 0.10 | 0.44 | 95.22 | 0.97 | 2.76 | 2.31 | 96.63 |
| OND163R-2-12-059 | | | | | | | | |
| NS1982.8-03 | 1.60 | 0.03 | 0.37 | 95.13 | 1.48 | 2.33 | 1.97 | 96.98 |
| NS1982.14-08 | 1.51 | 0.02 | 2.24 | 92.84 | 1.35 | 4.90 | 3.75 | 96.43 |
| NS1982.16 | 1.52 | 0.06 | 1.05 | 94.37 | 0.85 | 3.39 | 2.57 | 96.27 |
| H117R[4]// | 1.79 | 0.05 | 0.29 | 95.30 | 0.84 | 2.57 | 2.08 | 96.43 |
| H757B/LS10670B/// | | | | | | | | |
| NS1982.6-2-023-1-12-076 | | | | | | | | |
| H117R[4]// | 1.90 | 0.04 | 0.27 | 95.03 | 1.00 | 2.65 | 2.17 | 96.30 |
| H757B/LS10670B/// | | | | | | | | |
| NS1982.6-2-023-1-12-038 | | | | | | | | |
| H251B[2]/ | 1.47 | 0.24 | 2.59 | 92.59 | 0.65 | 5.42 | 4.06 | 95.83 |
| IAST-4 = 1 = 100// | | | | | | | | |
| NS1982.16-11-39-041 | | | | | | | | |
| OID263R/ | 3.08 | 0.12 | 0.27 | 93.54 | 1.48 | 3.87 | 3.35 | 95.29 |
| NS1982.8-4-12-002 | | | | | | | | |
| ON3351B/NS1982.8-1-04 | 2.04 | 0.03 | 0.50 | 95.20 | 0.70 | 3.08 | 2.54 | 96.40 |
| NS1982.8/ | 1.37 | 0.01 | 1.70 | 91.93 | 2.83 | 4.32 | 3.07 | 96.46 |
| OND163R-12-90 | | | | | | | | |
| H117R[4]// | 1.39 | 0.02 | 0.53 | 94.89 | 1.55 | 2.60 | 1.92 | 96.97 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.123) | | | | | | | | |
| H117R[4]// | 1.44 | 0.03 | 0.36 | 94.83 | 1.84 | 2.33 | 1.80 | 97.03 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.130) | | | | | | | | |
| H117R[4]// | 1.58 | 0.02 | 0.24 | 94.54 | 2.05 | 2.28 | 1.82 | 96.83 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.148) | | | | | | | | |
| H117R[4]// | 1.89 | 0.03 | 0.24 | 94.17 | 2.31 | 2.50 | 2.13 | 96.72 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.146) | | | | | | | | |
| H117R[4]// | 1.94 | 0.03 | 0.23 | 94.58 | 1.80 | 2.60 | 2.17 | 96.61 |
| H757B/LS10670B-B-17-3- | | | | | | | | |
| 23 = B1 = 2 = 16/// | | | | | | | | |
| NS1982.6-2-23.1-1 | | | | | | | | |
| (HE08EE017394.001.142) | | | | | | | | |

### Example 3

### Sunflower Oil Hydrogenation

Sunflower seed from the Reduced Saturate Sunflower (RSS) line, NS1982.8, was produced through traditional breeding methodologies. This Reduced Saturate Sunflower (RSS) line was deposited and made available to the public without restriction (but subject to patent rights), with the American Type Culture Collection (ATCC), 10801 University Boulevard, Manassas, Va., 20110. The deposit, designated as ATCC Deposit No. PTA-9677, was made on behalf of Dow AgroSciences LLC on Dec. 23, 2008. Characteristic seed oil from this line contains about 3.3% combined palmitic acid (16:0) and stearic acid (18:0) content. Stearin was produced via a hydrogenation method from oil obtained from the Reduced Saturate Sunflower line, NS1982.8, and compared to stearin that was produced via the hydrogenation method from conventional sunflower lines. FAME analysis of the NS1982.8 oil sample used, prior to hydrogenation, provided a determination of the sample's oil content: 1.3% C16:0; 2% C18:0; ˜92% C:18:1; and 4% C18:2.

Sunflower oil isolated from a conventional and the RSS sunflower line was hydrogenated using the following protocol. Initially, 1.100 kg of RSS or conventional sunflower oil was loaded into a Parr™ reactor (Moline, Ill.), and heated to 195° C. under a slight vacuum. A heat tape was wrapped to the discharge tube of the reactor to secure the discharge tube in place. In a beaker, 50 g of conventional or RSS sunflower oil was heated, and 1.2 g of N-820 Ni catalyst was added. The cocktail was stirred until the N-820 Ni catalyst pellets were dissolved. Once the Parr™ reactor reached a temperature of 195° C., the oil and catalyst mixture was drawn into the reactor with additional flushing of the beaker and discharge tube with 50 g of sunflower oil. Next, hydrogen gas was added at 50 psi.

After 120 minutes, the discharge tube was flushed with ˜3-5 mL of sunflower oil from the reactor. A collection of about 10 mL of the sunflower oil sample was made, bleaching clay was added to the oil, and it was then filtered. An iodine value (IV) was taken of the oil sample (American Oil Chemists' Society Test Method: AOCS Cd 1d-92), and, once the IV reached less than 5.0, the hydrogenation reaction was stopped. The oil within the reactor was cooled to 110° C., and 2% of Tonsil™ 126 bleaching clay (Sud Chemie, Louisville, Ky.) was added. The solution was mixed under a vacuum for 20 minutes and filtered.

A FAME analysis as described above in Example 1 was completed to determine the fatty acid profiles of the hydrogenated RSS and conventional sunflower oil. The results of the total seed oil content for the RSS and conventional sunflower lines are presented in Table 7.

The hydrogenation reaction for the RSS lines resulted in an increase of the concentration of stearin (C18:0). The increase in stearin levels was the product of the conversion of C18:1 and C18:2 to C18:0 by saturation of the C18:1 and C18:2 oils using the hydrogenation protocol. Surprisingly, the levels of stearin produced from the RSS lines (i.e., at least about 96% stearin) were significantly greater than the conventional sunflower line controls, which only resulted in a production of 86.2% stearin. These results demonstrate an unexpected benefit for the use of a new raw material, RSS oil, for the manufacture of higher purity stearin.

By using RSS oil, manufacturers will be able to hydrogenate the raw oil, thereby producing a higher purity stearin. The advantages of using RSS oil as compared to conventional sunflower are significant. Use of RSS oil requires the consumption of lower amounts of hydrogen gas, less energy needed for heating, and reduced processing times.

TABLE 7
The hydrogenated oil of Reduced Saturate Sunflower line was
quantitated via FAME analysis and compared to hydrogenated
oil obtained from conventional sunflower lines.

| | | Conventional |
|---|---|---|
| Line Name | RSS | Line |
| % Sats | 98.5% | 95.86% |
| C14:0 | — | 0.13% |
| C16:0 | 2.5% | 8.30% |
| C18:0 | 96.0% | 86.2% |
| C18:1 | — | 3.84% |
| C18:2 | — | 0.20% |
| C20:0 | — | 0.42% |
| C22:0 | — | 0.66% |
| C24:0 | — | 0.23% |
| Other | 1.5% | — |

Melt point = 130° F.

### Example 4

### Iodine Values

The IV determined for the hydrogenated RSS oil was used to determine the amount of saturation in fatty acids. Higher IV results correspond with more carbon double bonds that are present in the fat, and provide an indication of the amount of oxidation. Samples were dissolved in CCl₄, and 25 mL of 0.1 M Wijs solution was added. The reaction was allowed to run to completion in the dark for approximately 1 hour, or longer if necessary.

Deionized water was added, and the excess iodine was titrated with sodium thiosuphate. IV values were determined with a Mettler Titrator™ (Mettler Toledo, Columbus, Ohio). The iodine value is defined as the weight of iodine absorbed by 100 gm of an oil or fat.

The hydrogenated RSS oil gave an IV of 1.14.

### Example 5

### Synthesis of Fully-Saturated Sunflower Oil from Crude No-Sat Sunflower Oil

A sample of crude Reduced Saturate Sunflower oil (lot 2008-670-2) was obtained, and the sample appeared as a dark yellow oil. 2.20 g of the crude no-sat sunflower oil sample was placed into a 500 mL thick-walled hydrogenation vessel, and toluene (58 g) was added to give a colorless solution. The solution was degassed by bubbling a steam of nitrogen for 5 minutes. Palladium on activated carbon (5% by wt, 295 mg) was added.

The vessel was attached to a Parr™ Hydrogenator, and hydrogen gas was applied at 40 psi to the vessel only. After 4 hours, the pressure in the vessel had dropped to 33 psi. The vessel was removed, and the reaction mixture was passed through a 0.45 micron syringe filter to remove the catalyst. The resulting colorless solution was treated with ethyl acetate (60 mL) to give a colorless solution. A white precipitate formed slowly over 1 hour. The solid (0.467 g) was collected by vacuum filtration, and it had a melting point of 72-73° C.

### Example 6

### Synthesis of Fully-Saturated Sunflower Oil from Mid Oleic Sunflower Oil

A sample of mid-oleic sunflower oil (lot 2005-1031-0002) was obtained. Sunflower varieties can be produced that yield seeds having a mid oleic acid content (e.g., 55% to 75% oleic acid). Sunflower oils having such fatty acid contents have an oxidative stability that is higher than oils with a lower oleic acid content. The sample of mid-oleic sunflower oilappeared as a light yellow/colorless oil. 2.45 g of the mid-oleic sunflower oil was placed into a 500 mL thick-walled hydrogenation vessel, and toluene (48 g) was added to give a colorless solution. The solution was degassed by bubbling a steam of nitrogen for 5 minutes. Palladium on activated carbon (5% by wt, 295 mg) was added.

The vessel was attached to a Parr™ Hydrogenator, and hydrogen gas was applied at 40 psi to the vessel only. After 1 hour, the pressure in the vessel had dropped to 32 psi. An additional 2 hour resulted in no change in the vessel pressure. The vessel was removed, and the reaction mixture was passed through a 0.45 micron syringe filter to remove the catalyst. The resulting colorless solution was treated with ethyl acetate (60 mL) to give a colorless solution. A white precipitate formed slowly over 1 hour. The mixture was cooled to 0° C. in an ice bath, and the solid (1.2 g) was collected by vacuum filtration. This solid had a melting point of 70-71° C.

### Example 7

### Synthesis of Fully-Saturated Sunflower Oil from High Oleic Sunflower Oil

A sample of high-oleic sunflower oil (lot 2006-1032-0001) was obtained. Sunflower varieties can be produced that yield seeds having a high oleic acid content, comprising an oil content of at least 80% oleic acid. High oleic acid sunflower oil is a stable oil (without hydrogenation) with a neutral taste profile. High oleic sunflower oil is ideal for products or production processes requiring a nutritional vegetable oil with naturally high stability and additives. The high oleic sunflower oil sample appeared as a colorless oil. A sample of fully-saturated oil was also obtained. The fully-saturated sample appeared as a white flake wax. A qualitative determination of the solubility of the saturated oil sample was evaluated in different solvents (chloroform, toluene, ethyl acetate, THF, and methyl t-butyl ether), and the compound was only soluble in chloroform (>0.1 g/mL) and toluene (˜0.1 g/mL).

A sample of the high oleic sunflower oil (2.12 g) was placed into a 500 mL thick-walled hydrogenation vessel, and toluene (42 g) was added to give a colorless solution. The solution was degassed by bubbling a steam of nitrogen for 5 minutes. Palladium on activated carbon (5% by wt, 350 mg) was added. The vessel was attached to a Parr™ Hydrogenator, and hydrogen gas applied at 40 psi to the vessel only. After 1 hour, the pressure in the vessel had dropped to 34 psi. An additional 4 hour resulted in no change in the vessel pressure. The vessel was removed and stored under ambient conditions for 18 hours.

A small portion of the reaction medium (black suspension, 1 mL) was removed and passed through a 0.2 micron syringe filter to remove the catalyst, giving a colorless solution. The solvent was removed with a heavy stream of nitrogen (15 minutes) to give a white waxy solid. The solid was analyzed by ¹H-NMR, and compared to the ¹H-NMR spectrum of the starting oil. The NMR results indicated complete saturation of the high-oleic oil. The remaining reaction mixture was passed through a 0.45 micron syringe filter to remove the catalyst and the resulting colorless solution was treated with ethyl acetate (60 mL) to give a colorless solution. A white precipitate formed slowly over 1 hour. The mixture was cooled to 0° C. in an ice bath, and the white solid (0.537 g) was collected by vacuum filtration. The white solid had a melting point of 69-70° C., and it was analyzed by ¹H-NMR and EA.

TABLE 8
Fully-saturated sunflower oil analysis.

| | Total | | | | |
|---|---|---|---|---|---|
| | Trans | Total | | | |
| Sample | Fats | Saturates | C10:0 | C12:0 | C13:0 |
| High Stearic RBD | 0.04 | 23.05 | nd | nd | nd |
| Sunflower Oil | | | | | |
| RBD Alpha ETS Oil | 0.08 | 7.02 | nd | nd | nd |
| No Sat Sunflower | 0.09 | 3.06 | 0.01 | nd | nd |
| RBD | | | | | |
| RBD High Palmitic | 0.04 | 18.74 | nd | nd | nd |
| Sunflower | | | | | |
| High Oleic | 0.01 | 7.76 | 0.02 | nd | nd |
| Sunflower | | | | | |
| Crude DAS- | 0.04 | 3.47 | nd | nd | nd |
| extracted Reduced | | | | | |
| Sat Sunflower | | | | | |
| Mid Oleic | 0.17 | 9.47 | nd | nd | 0.01 |
| Sunflower | | | | | |
| Sample | C14:0 | C14:1 | C15:0 | C15:1 | C16:0 |
| High Stearic RBD | 0.03 | nd | 0.03 | nd | 4.01 |
| Sunflower Oil | | | | | |
| RBD Alpha ETS Oil | 0.03 | nd | 0.01 | nd | 2.92 |
| No Sat Sunflower | 0.02 | nd | 0.01 | nd | 1.91 |
| RBD | | | | | |
| RBD High Palmitic | 0.03 | nd | 0.02 | nd | 15.6 |
| Sunflower | | | | | |
| High Oleic | 0.03 | nd | 0.01 | nd | 3.11 |
| Sunflower | | | | | |
| Crude DAS- | 0.02 | nd | 0.01 | nd | 1.81 |
| extracted Reduced | | | | | |
| Sat Sunflower | | | | | |
| Mid Oleic | 0.05 | nd | 0.02 | nd | 4.38 |
| Sunflower | | | | | |
| | C16:1 | | | | |
| Sample | trans | C16:1 | C17:0 | C17:1 | C18:0 |
| High Stearic RBD | 0.03 | 0.03 | 0.08 | 0.03 | 15.48 |
| Sunflower Oil | | | | | |
| RBD Alpha ETS Oil | 0.03 | 0.07 | 0.03 | 0.04 | 2.7 |
| No Sat Sunflower | 0.03 | 0.03 | 0.02 | 0.04 | 0.52 |
| RBD | | | | | |
| RBD High Palmitic | nd | 3.92 | 0.02 | 0.05 | 1.44 |
| Sunflower | | | | | |
| High Oleic | 0.02 | 0.07 | 0.04 | 0.05 | 3.23 |
| Sunflower | | | | | |
| Crude DAS- | 0.03 | 0.03 | 0.03 | 0.07 | 0.9 |
| extracted Reduced | | | | | |
| Sat Sunflower | | | | | |
| Mid Oleic | 0.01 | 0.08 | 0.04 | 0.04 | 3.62 |
| Sunflower | | | | | |
| | C18:1 | | | | |
| | trans | | | | |
| | (petro- | C18:1 | | | C18:2 |
| | selai- | trans | C18:1 | C18:1 | trans, |
| Sample | date) | (eliadate) | (Oleic) | (vaccinic) | trans |
| High Stearic RBD | nd | 0.01 | 68.47 | nd | nd |
| Sunflower Oil | | | | | |
| RBD Alpha ETS Oil | nd | 0.03 | 89.43 | nd | nd |
| No Sat Sunflower | nd | 0.03 | 91.92 | nd | nd |
| RBD | | | | | |
| RBD High Palmitic | nd | 0.02 | 70.58 | 3.17 | nd |
| Sunflower | | | | | |
| High Oleic | nd | 0.06 | 86.92 | nd | nd |
| Sunflower | | | | | |
| Crude DAS- | nd | 0.01 | 93.54 | nd | nd |
| extracted Reduced | | | | | |
| Sat Sunflower | | | | | |
| Mid Oleic | nd | 0.1 | 59.52 | nd | nd |
| Sunflower | | | | | |
| | | C18:3 | | C18:3 | |
| Sample | C18:2 | gamma | C19:0 | alpha | C20:0 |
| High Stearic RBD | 7.94 | 0.01 | 0.04 | 0.12 | 1.13 |
| Sunflower Oil | | | | | |
| RBD Alpha ETS Oil | 2.87 | nd | nd | 0.06 | 0.25 |
| No Sat Sunflower | 3.95 | nd | 0.03 | 0.1 | 0.07 |
| RBD | | | | | |
| RBD High Palmitic | 2.9 | nd | 0.01 | 0.09 | 0.21 |
| Sunflower | | | | | |
| High Oleic | 4.56 | nd | 0.03 | 0.07 | 0.28 |
| Sunflower | | | | | |
| Crude DAS- | 1.52 | nd | 0.03 | 0.08 | 0.1 |
| extracted Reduced | | | | | |
| Sat Sunflower | | | | | |
| Mid Oleic | 28.94 | nd | 0.08 | 0.92 | 0.32 |
| Sunflower | | | | | |
| | | | | C20:3 | |
| | C20:1 | | | homo- | |
| Sample | trans | C20:1 | C20:2 | gamma | C20:4 |
| High Stearic RBD | 0.01 | 0.11 | nd | nd | nd |
| Sunflower Oil | | | | | |
| RBD Alpha ETS Oil | 0.02 | 0.3 | nd | nd | nd |
| No Sat Sunflower | 0.02 | 0.65 | nd | nd | nd |
| RBD | | | | | |
| RBD High Palmitic | 0.02 | 0.26 | nd | nd | nd |
| Sunflower | | | | | |
| High Oleic | 0.01 | 0.27 | nd | nd | nd |
| Sunflower | | | | | |
| Crude DAS- | nd | 0.65 | nd | nd | nd |
| extracted Reduced | | | | | |
| Sat Sunflower | | | | | |
| Mid Oleic | 0.06 | 0.32 | 0.02 | nd | nd |
| Sunflower | | | | | |
| | | | | C22:1 | |
| Sample | C20:3 | C22:0 | C20:5 | trans | C22:1 |
| High Stearic RBD | nd | 2.01 | nd | nd | nd |
| Sunflower Oil | | | | | |
| RBD Alpha ETS Oil | nd | 0.77 | nd | nd | nd |
| No Sat Sunflower | nd | 0.33 | nd | nd | 0.03 |
| RBD | | | | | |
| RBD High Palmitic | nd | 1.02 | nd | nd | 0.01 |
| Sunflower | | | | | |
| High Oleic | nd | 0.79 | nd | nd | nd |
| Sunflower | | | | | |
| Crude DAS- | 0.07 | 0.41 | nd | nd | nd |
| extracted Reduced | | | | | |
| Sat Sunflower | | | | | |
| Mid Oleic | nd | 0.78 | nd | nd | nd |
| Sunflower | | | | | |

| | | | C22:6 | |
|---|---|---|---|---|
| Sample | C22:2 | C24:0 | (DHA) | C24:1 |
| High Stearic RBD | nd | 0.3 | 0 | 0.01 |
| Sunflower Oil | | | | |
| RBD Alpha ETS Oil | nd | 0.3 | nd | nd |
| No Sat Sunflower | nd | 0.2 | nd | nd |
| RBD | | | | |
| RBD High Palmitic | nd | 0.41 | nd | nd |
| Sunflower | | | | |
| High Oleic | 0.03 | 0.26 | nd | nd |
| Sunflower | | | | |
| Crude DAS- | nd | 0.19 | nd | nd |
| extracted Reduced | | | | |
| Sat Sunflower | | | | |
| Mid Oleic | nd | 0.25 | nd | 0.03 |
| Sunflower | | | | |

TABLE 9
Fully Saturated Sunflower Oil Analysis

| | Total | Total | | | |
|---|---|---|---|---|---|
| | Satur- | Trans- | | | |
| Sample | ates | fats | C10:0 | C12:0 | C13:0 |
| Hyd. low sat. | 96.73 | 2.46 | nd | 0.02 | 0.03 |
| sunflower oil from | | | | | |
| crude oil (lot 2008- | | | | | |
| 670-2) | | | | | |
| Commercial F.H. | 99.14 | 0.19 | nd | 0.04 | nd |
| Cotton | | | | | |
| Commercial F.H. | 99.44 | 0.29 | 0.11 | 1.13 | nd |
| Palm | | | | | |
| Commercial F.H. | 99.24 | 0.28 | nd | 0.01 | nd |
| Soybean | | | | | |
| Hyd. High Oleic | 99.84 | nd | nd | nd | nd |
| Sunflower | | | | | |
| Sample | C14:0 | C14:1 | C15:0 | C15:1 | C16:0 |
| Hyd. low sat. | 0.04 | nd | 0.03 | nd | 1.62 |
| sunflower oil from | | | | | |
| crude oil (lot 2008- | | | | | |
| 670-2) | | | | | |
| Commercial F.H. | 0.62 | nd | 0.04 | nd | 22.16 |
| Cotton | | | | | |
| Commercial F.H. | 1.60 | nd | 0.07 | 0.01 | 60.37 |
| Palm | | | | | |
| Commercial F.H. | 0.12 | nd | 0.06 | nd | 11.27 |
| Soybean | | | | | |
| Hyd. High Oleic | 0.05 | nd | 0.02 | nd | 5.24 |
| Sunflower | | | | | |
| | C16:1 | | | | |
| Sample | trans | C16:1 | C17:0 | C17:1 | C18:0 |
| Hyd. low sat. | nd | nd | 0.07 | 0.12 | 93.63 |
| sunflower oil from | | | | | |
| crude oil (lot 2008- | | | | | |
| 670-2) | | | | | |
| Commercial F.H. | nd | nd | 0.26 | nd | 75.26 |
| Cotton | | | | | |
| Commercial F.H. | nd | nd | 0.15 | nd | 35.40 |
| Palm | | | | | |
| Commercial F.H. | nd | nd | 0.36 | 0.04 | 86.35 |
| Soybean | | | | | |
| Hyd. High Oleic | nd | nd | 0.12 | nd | 91.90 |
| Sunflower | | | | | |
| | C18:1 | | | | |
| | trans | | | | |
| | (petro- | C18:1 | | C18:1 | C18:2 |
| | selai- | trans | C18:1 | (vac- | trans, |
| Sample | date) | (elaidic) | (Oleic) | cenic) | trans, |
| Hyd. low sat. | nd | 2.44 | 0.47 | nd | 0.02 |
| sunflower oil from | | | | | |
| crude oil (lot 2008- | | | | | |
| 670-2) | | | | | |
| Commercial F.H. | nd | 0.19 | 0.08 | nd | nd |
| Cotton | | | | | |
| Commercial F.H. | nd | 0.29 | 0.16 | 0.01 | 0.00 |
| Palm | | | | | |
| Commercial F.H. | nd | 0.27 | 0.14 | 0.01 | 0.01 |
| Soybean | | | | | |
| Hyd. High Oleic | nd | nd | 0.00 | nd | nd |
| Sunflower | | | | | |
| | | C18:3 | | C18:3 | |
| Sample | C18:2 | gamma | C19:0 | alpha | C20:0 |
| Hyd. low sat. | 0.04 | 0.06 | nd | nd | 0.74 |
| sunflower oil from | | | | | |
| crude oil (lot 2008- | | | | | |
| 670-2) | | | | | |
| Commercial F.H. | 0.02 | 0.05 | nd | nd | 0.43 |
| Cotton | | | | | |
| Commercial F.H. | 0.01 | 0.01 | nd | nd | 0.45 |
| Palm | | | | | |
| Commercial F.H. | 0.02 | 0.07 | nd | nd | 0.58 |
| Soybean | | | | | |
| Hyd. High Oleic | nd | 0.05 | nd | nd | 0.77 |
| Sunflower | | | | | |
| | | | | C20:3 | |
| | C20:1 | | | homo- | |
| Sample | trans | C20:1 | C20:2 | gamma | C20:4 |
| Hyd. low sat. | nd | nd | nd | nd | nd |
| sunflower oil from | | | | | |
| crude oil (lot 2008- | | | | | |
| 670-2) | | | | | |
| Commercial F.H. | nd | nd | nd | nd | nd |
| Cotton | | | | | |
| Commercial F.H. | nd | nd | nd | nd | nd |
| Palm | | | | | |
| Commercial F.H. | nd | nd | nd | nd | nd |
| Soybean | | | | | |
| Hyd. High Oleic | nd | nd | nd | nd | nd |
| Sunflower | | | | | |
| | | | | C22:1 | |
| Sample | C20:3 | C22:0 | C20:5 | trans | C22:1 |
| Hyd. low sat. | nd | 0.40 | nd | nd | nd |
| sunflower oil from | | | | | |
| crude oil (lot 2008- | | | | | |
| 670-2) | | | | | |
| Commercial F.H. | nd | 0.20 | nd | nd | nd |
| Cotton | | | | | |
| Commercial F.H. | nd | 0.08 | nd | nd | nd |
| Palm | | | | | |
| Commercial F.H. | nd | 0.36 | nd | nd | nd |
| Soybean | | | | | |
| Hyd. High Oleic | nd | 1.30 | nd | nd | nd |
| Sunflower | | | | | |
| | | | | | Phospho- |
| Sample | C22:2 | C24:0 | C22:6 | C24:1 | lipids |
| Hyd. low sat. | nd | 0.20 | nd | nd | nd |
| sunflower oil from | | | | | |
| crude oil (lot 2008- | | | | | |
| 670-2) | | | | | |
| Commercial F.H. | nd | 0.11 | nd | nd | nd |
| Cotton | | | | | |
| Commercial F.H. | nd | 0.07 | nd | nd | nd |
| Palm | | | | | |
| Commercial F.H. | nd | 0.12 | nd | nd | nd |
| Soybean | | | | | |
| Hyd. High Oleic | 0.05 | 0.46 | nd | nd | |
| Sunflower | | | | | |
| | | | | | Free |
| | | | | | fatty |
| Sample | Polymers | TAGs | DAGs | MAGs | acids |
| Hyd. low sat. | nd | 95.88 | nd | nd | 4.13 |
| sunflower oil from | | | | | |
| crude oil (lot 2008- | | | | | |
| 670-2) | | | | | |
| Commercial F.H. | 0.26 | 99.74 | nd | nd | nd |
| Cotton | | | | | |
| Commercial F.H. | 0.47 | 99.34 | nd | nd | 0.19 |
| Palm | | | | | |
| Commercial F.H. | nd | 100 | nd | nd | nd |
| Soybean | | | | | |
| Hyd. High Oleic | | | | | |
| Sunflower | | | | | |

### Example 8

### Manufacture of Candles from High Purity Stearin

Candles are made from hydrogenated RSS oil (i.e., high purity stearin). The hydrogenated RSS oil is completely melted to a molten state in a 100 mL beaker by heating to 160° F. The melted RSS oil is mixed for 5 minutes with a glass stirrer to ensure all of the hard fat components are thoroughly mixed. Blends of the hydrogenated RSS oil and non-hydrogenated oil are made at the following ratios: 100% hydrogenated RSS oil; 90% hydrogenated RSS oil+10% liquid oil; 80% hydrogenated RSS oil+20% liquid oil; 75% hydrogenated RSS oil+25% liquid RSS oil; and 70% hydrogenated RSS oil+30% liquid RSS oil.

The 100% and 90:10% blends are used to make block candles, and the 80:20%, 75:25%, and 70:30% blends are used to make jar candles. The blends are mixed for 5 minutes, while maintaining a temperature of 160° F. To avoid the formation of fat crystals within the candle and candles that are non-homogenous and inconsistent in texture, the blended oils are allowed to slowly cool (no more than ˜5° F. per minute), while continually being stirred.

As the temperature of the mixture approaches 100-120° F., the mixture is poured into molding jars that contain a candle wick positioned at the base of the molding jar. The molds are stored at ambient temperatures of 70-80° F. for 4 hours, during which time the mixture hardens in the molding jar. The mixture is allowed to cool naturally. After four hours the candles are lit, and the flame is observed for consistency.

The use of hydrogenated stearin which is produced from RSS oil results in the production of high quality candles, which burn consistently with little to no aroma.

What may be claimed is:

1. A composition suitable for hardening into the shape of a candle, wherein the composition comprises stearin produced by hydrogenating a sunflower oil comprising no more than about 4% total saturated fat.

2. The composition of claim 1, wherein the composition comprises liquid oil.

3. The composition of claim 2, wherein the liquid oil is a Reduced Saturate Sunflower (RSS) oil.

4. The composition of claim 1, wherein the composition consists essentially of vegetable oil.

5. The composition of claim 1, wherein the composition comprises at least one additive.

6. The composition of claim 5, wherein the additive is selected from the group consisting of a coloring agent; a botanical; an aromatic compound; titanium dioxide; a candle glaze; vybar; and a UV stabilizer.

7. The composition of claim 1, wherein the sunflower oil comprises at least about 88% oleic acid (18:1).

8. The composition of claim 1, wherein the sunflower oil comprises at least about 92% oleic acid (18:1).

9. The composition of claim 1, wherein the sunflower oil comprises less than about 4% combined 16:0 and 16:1 fatty acids.

10. The composition of claim 1, wherein the sunflower oil comprises less than about 3% combined 16:0 and 16:1 fatty acids.

11. The composition of claim 1, wherein the sunflower oil comprises less than about 4% palmitic acid (16:0).

12. The composition of claim 1, wherein the sunflower oil comprises less than about 3% palmitic acid (16:0).

13. The composition of claim 1, wherein the sunflower oil comprises at least about 90% oleic acid (18:1).

14. The composition of claim 1, wherein the sunflower oil comprises at least about 92% oleic acid (18:1).

15. The composition of claim 1, wherein the sunflower oil comprises less than or equal to about 4% total combined palmitic acid (16:0) and stearic acid (18:0).

16. The composition of claim 1, wherein the sunflower oil comprises less than or equal to about 3.3% total combined palmitic acid (16:0) and stearic acid (18:0).

17. The composition of claim 1, wherein the sunflower oil comprises up to about 94% oleic acid (18:1) and less than about 4% palmitic acid (16:0).

18. The composition of claim 1, wherein the sunflower oil comprises up to about 94% oleic acid (18:1) and less than about 2.1% palmitic acid (16:0).

19. The composition of claim 1, wherein the hydrogenated sunflower oil comprises a combined stearic acid and palmitic acid content of at least about 98% of the total fatty acids in the hydrogenated sunflower oil.

20. A method for manufacturing a candle, the method comprising:
providing the composition of claim 1;
heating the composition until it is in a molten state;
cooling the molten composition into a solid form; and
finishing the candle from the solid form.

21. The method according to claim 20, wherein finishing the candle from the solid form comprises providing the solid form as the shape of the finished candle.

22. The method according to claim 20, wherein finishing the candle from the solid form comprises sculpting, cutting, or shaping the solid form into the shape of the finished candle.

23. The method according to claim 20, wherein the method comprises stirring the molten composition.

24. The method according to claim 20, wherein the method comprises admixing an additive with the molten composition.

25. The method according to claim 20, wherein cooling the molten composition into a solid form comprises dipping a solid form comprising a wick into the molten mixture and removing the dipped form from the molten mixture.

26. A candle manufactured by the process according to claim 20.

27. The candle of claim 26, wherein the candle is a jar candle.

28. The candle of claim 26, wherein the candle is a block candle.

29. The candle of claim 26, wherein the composition essentially consists of vegetable oil.
